(19) United States
(12) Patent Application Publication
(10) Pub. No.: US 2005/0213785 A1
(43) Pub. Date: Sep. 29, 2005

(54) Piezoelectric speaker, speaker system employing it, and electronic apparatus employing piezoelectric speaker

(75) Inventors: Satoshi Koura, Ischishi-gun, Mie (JP); Shoji Nakajima, Tsu-shi Mie (JP); Shinya Mizone, Tsu-shi Mie (JP); Jiro Terada, Hirakata-shi Osaka (JP)

Correspondence Address: RATNERPRESTIA, P O BOX 980, VALLEY FORGE, PA, 19482-0980, US

(73) Assignee: Matsushita Electric Industrial Co., Ltd., Osaka (JP)

(21) Appl. No.: 10/511,890

(22) PCT Filed: Dec. 9, 2003
(86) PCT No.: PCT/JP03/15715

§ 371 Date: Oct. 19, 2004

(30) Foreign Application Priority Data
Jan. 10, 2003 (JP) 2003-4452

(51) Int. Cl. H04R 25/00

(52) U.S. Cl. 381/190; 381/152

(57) ABSTRACT

A piezoelectric loudspeaker includes: a diaphragm; a first piezoelectric material provided in a first area of the diaphragm; and a second piezoelectric material provided in a second area of the diaphragm different from the first area. The second area has a sound reproduction band different from that of the first area. This piezoelectric loudspeaker has a wide reproduction frequency range.

### TECHNICAL FIELD

The present invention relates to a piezoelectric loudspeaker employing a piezoelectric material, a loudspeaker system using the loudspeaker, and an electronic device using the loudspeaker.

### PRIOR ART

A conventional piezoelectric loudspeaker employing a piezoelectric material disclosed in Japanese Laid-Open Publication No. 11-164396 includes a single diaphragm and a single piezoelectric material provided at the diaphragm.

Since having the single diaphragm and piezoelectric material, the conventional piezoelectric loudspeaker has difficulty in reproducing of a sound in wide frequency range. Specifically, this loudspeaker having the piezoelectric material vibrating by deforming causes the piezoelectric material to have a high Q factor, hence having a narrow reproducing frequency range.

### SUMMARY OF THE INVENTION

A piezoelectric loudspeaker includes: a diaphragm; a first piezoelectric material provided in a first area of the diaphragm; and a second piezoelectric material provided in a second area of the diaphragm different from the first area. The second area has a sound reproduction band different from that of the first area. This piezoelectric loudspeaker has a wide reproduction frequency range.

### BRIEF DESCRIPTION OF THE DRAWINGS

FIG. 1 is a perspective view of a loudspeaker box according to an exemplary embodiment of the present invention.

FIG. 2 is a perspective view of a tweeter according to the embodiment.

FIG. 3 shows a sound pressure frequency characteristic of the tweeter according to the embodiment.

FIG. 4 is a cross-sectional view of the tweeter shown in FIG. 2 taken at line 4-4.

FIG. 5 is a block diagram of an electronic device according to the embodiment.

FIG. 6 is a perspective view of another tweeter box according to the embodiment.

### DESCRIPTION OF THE PREFERRED EMBODIMENT

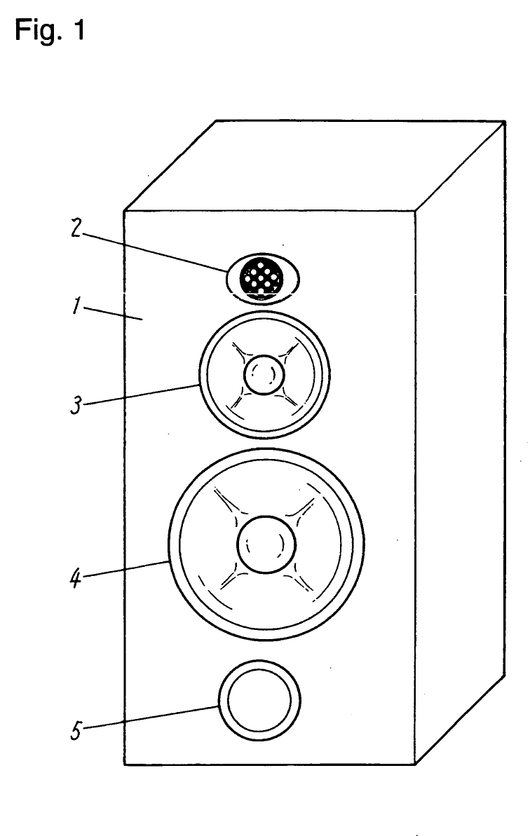

FIG. 1 is a perspective view of a loudspeaker system according to an exemplary embodiment of the present invention. A front face of loudspeaker box 1 having a rectangular shape has tweeter 2, squawker 3, woofer 4, and bass-reflex port 5 provided from the upper direction to the lower direction. Tweeter 2 has a sound reproduction frequency range, such as 5 kHz to 100 kHz. Squawker 3 has a sound reproduction frequency range from 500 Hz to 5 kHz. Woofer 4 has a sound reproduction frequency range from 20 Hz to 500 Hz. Bass-reflex port 5 emphasizes a portion lower than 100 Hz in the reproduction range of woofer 4.

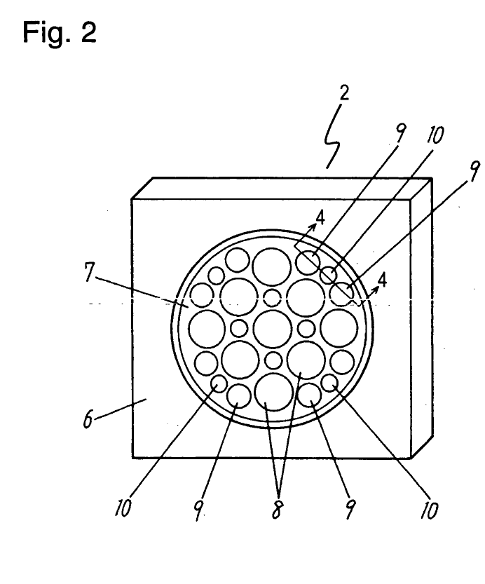

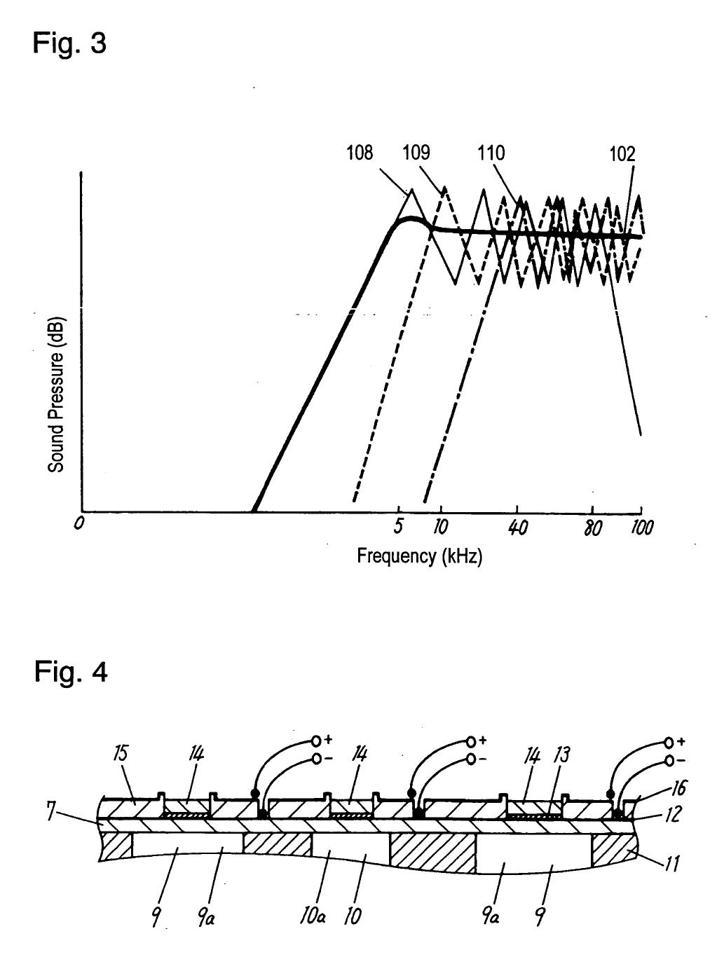

FIG. 2 is a perspective view of tweeter 2 according to the embodiment. FIG. 3 shows a sound pressure frequency characteristic of tweeter 2. Tweeter 2 includes tweeter box 6 and a single diaphragm 7 exposed at the front face of the tweeter. As shown in FIG. 2, diaphragm 7 includes plural areas 8, plural areas 9 smaller than areas 8, and plural areas 10 smaller than areas 9. As shown in FIG. 3, area 8 has characteristic 108 having a sound reproduction frequency range from 5 kHz to 80 kHz. Area 9 has characteristic 109 having a sound reproduction frequency range from 10 kHz to 100 kHz. Area 10 has characteristic 110 having a sound reproduction frequency range from 40 kHz to 100 kHz. Areas 8, 9, and 10 compose tweeter 2 having characteristic 102 of a range from 5 kHz to 100 kHz as the combination of the sound frequency ranges.

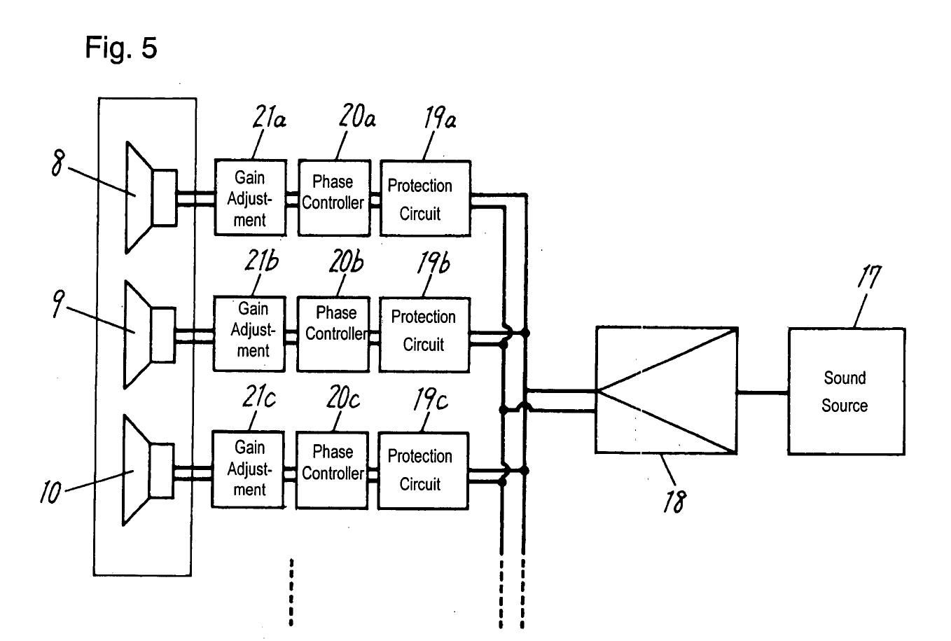

FIG. 4 is a cross-sectional view of diaphragm 7 of tweeter 2 shown in FIG. 2 taken at line 4-4. Areas 8 to 10 are provided on diaphragm 7. Diaphragm 7 is made of SiO₂ and has a thickness of 30000 Å. A back face of diaphragm 7 has base 11 that is made of Si and has a thickness of 500 μm. Base 11, a frame body provided around openings 8a to 10a, has openings 8a to 10a corresponding to areas 8 to 10, respectively (opening 8a is not shown). Openings 8a to 10a have respective areas corresponding to areas 8 to 10 so that opening 9a is smaller than opening 8a while opening 10a is smaller than opening 9a. The base as the frame body provides areas 8 to 10 with sound reproduction frequency ranges different from each other easily.

Diaphragm 7 has lower electrodes 12 made of platinum thereon. Lower electrodes 12 corresponding to openings 8a to 10a has thereon piezoelectric thin film 14 via buffer layer 13. Piezoelectric thin film 14 is ceramic of mixture of lead titanate and lead zirconate consisting of PZT. Lower electrodes 12 around piezoelectric thin films 14 have thereon insulating films 15 made of resin on which upper electrodes 16 are provided, respectively. Piezoelectric thin films 14 may be provided on diaphragm 7 at once by a piezoelectric-thin-film-forming process.

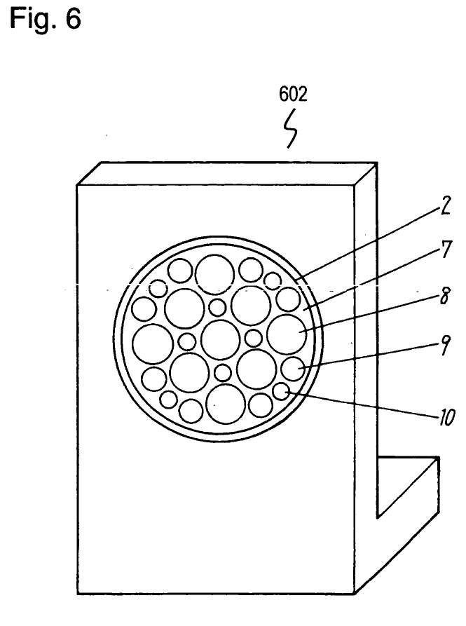

FIG. 5 is a block diagram of an electronic device according to the embodiment. As shown in FIG. 5, piezoelectric thin films 14 corresponding to areas 8 to 10, respectively, are fed with sound source signals via upper electrodes 16. Sound source 17 is connected with amplifier 18 and amplifier 18 is connected to piezoelectric thin films 14 of areas 8 to 10 in parallel to each other. Piezoelectric thin films 14 of areas 8 to 10 and amplifier 18 have protection circuits 19a to 19c for preventing over-currents between thisn films and the amplifier. Phase controllers 20a to 20c control phases of signals applied to areas 8 to 10, respectively. Gain adjustment circuits 21a to 21c adjust the amplitudes of signals applied to areas 8 to 10, respectively. This structure provides tweeter 2 with a flat sound pressure frequency characteristic shown in characteristic 102 of FIG. 3 in a wide and high frequency range from 5 kHz to 100 kHz.

Sounds in a nature include frequency components higher than 20 kHz, which human beings cannot hear. For example, a musical instrument, such as a cymbal, emits a sound having a component higher than 20 kHz. Human beings hear a sound from 20 Hz to 20 kHz out of a combination and interference of such sounds having such high frequency components.

Therefore, tweeter 2 of the embodiment reproducing a sound from 5 kHz to 100 kHz can reproduce sounds more naturally. Thus, it is recently said that sound source 17, such as an audio device, needs to output a signal having a frequency up to 100 kHz.

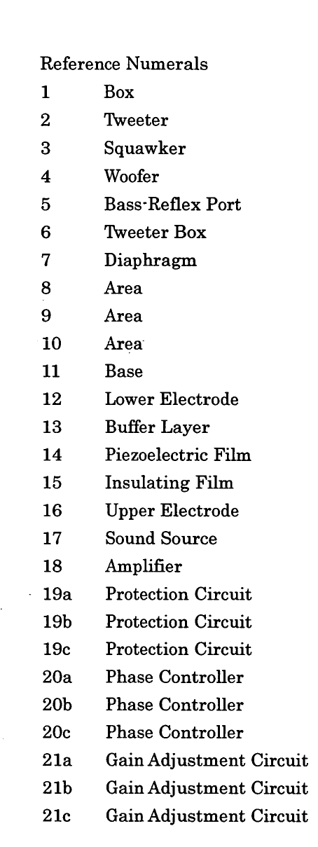

FIG. 6 shows another tweeter 602 according to the embodiment. Tweeter 602 is of a so-called add-on-type for emphasizing a treble added to an existing electronic device. Tweeter 602 includes therein protection circuits 19a to 19c, phase controllers 20a to 20c, and gain adjustment circuits 21a to 21c shown in FIG. 5 and has at the back face side a connection terminal for the connection to amplifier 18.

Tweeter 2 as a piezoelectric loudspeaker according to the embodiment has areas 8 to 10 having sizes different from each other. The number of the areas different from each other is not limited to three and thus may be two or more, hence providing the same effects as those of the loudspeaker according to the embodiment.

### INDUSTRIAL APPLICABILITY

As described above, the piezoelectric loudspeaker according to the present invention has a wide reproduction frequency range.

1. A piezoelectric loudspeaker comprising:
a diaphragm;
a first piezoelectric material provided in a first area of the diaphragm; and
a second piezoelectric material provided in a second area of the diaphragm different from the first area, second piezoelectric material having a sound reproduction frequency range different from band from a sound reproduction frequency range of the first area.

2. The piezoelectric loudspeaker according to claim 1, wherein the first and second piezoelectric materials include first and second piezoelectric thin films, respectively.

3. The piezoelectric loudspeaker according to claim 1, wherein the first and second areas have sizes different from each other.

4. The piezoelectric loudspeaker according to claim 1, wherein the first and second piezoelectric materials have sizes different from each other.

5. The piezoelectric loudspeaker according to claim 1, wherein the first and second piezoelectric materials are provided on a first face of the diaphragm.

6. The piezoelectric loudspeaker according to claim 5, further comprising a frame body provided on a second face of the diaphragm and provided around the first and second areas.

7. A loudspeaker system comprising:
a piezoelectric loudspeaker including
a diaphragm,
a first piezoelectric material provided in a first area of the diaphragm, and
a second piezoelectric material provided in a second area of the diaphragm different from the first area, second piezoelectric material having a sound reproduction frequency range different from band from a sound reproduction frequency range of the first area; and
another loudspeaker having a sound reproduction frequency range lower than the sound reproduction frequency ranges of the first and second areas of the piezoelectric loudspeaker.

8. An electronic device comprising:
a piezoelectric loudspeaker including
a diaphragm,
a first piezoelectric material provided in a first area of the diaphragm, and
a second piezoelectric material provided in a second area of the diaphragm different from the first area, second piezoelectric material having a sound reproduction frequency range different from band from a sound reproduction frequency range of the first area; and
a sound source connected to the piezoelectric loudspeaker.
